(19) United States
(12) Patent Application Publication
(10) Pub. No.: US 2010/0114476 A1
(43) Pub. Date: May 6, 2010

(54) INTELLIGENT NAVIGATION DEVICE AND CONTROL METHOD THEREOF

(75) Inventor: Ying-Lan Hsu, Taipei City (TW)

Correspondence Address: NIKOLAI & MERSEREAU, P.A., 900 SECOND AVENUE SOUTH, SUITE 820, MINNEAPOLIS, MN, 55402, US

(73) Assignee: QUANTUM DIGITAL COMMUNICATION TECHNOLOGY CORP., Taipei City (TW)

(21) Appl. No.: 12/409,776

(22) Filed: Mar. 24, 2009

(30) Foreign Application Priority Data
Oct. 31, 2008 (TW) 97141961

(51) Int. Cl. G01C 21/36

(52) U.S. Cl. 701/201; 701/209

(57) ABSTRACT

A control method for an intelligent navigation device which has a plurality of electronic map images is provided. The steps of the above mentioned control method includes first, inputting a target position; then, generating a navigation path on the electronic map image according to a location information of the intelligent navigation device and the target position, wherein there are a plurality of point of interest (POI) images on the electronic map images; lastly, selecting one of the POI image and entering its website.

### BACKGROUND OF THE INVENTION

1. Field of the Invention

The present invention relates to a navigation device and a control method thereof, in particular, to an intelligent navigation device and a control method thereof.

2. Description of Related Art

As the technology in the field of electronics progresses, and as the technology of global position system (GPS) becomes more common, most the current car manufacturer has added a navigation device in the car so that drivers may accurately realize heading, so as to quickly arrive at a destination. Further, due to the progress of technology, the reduction of production cost, and the increase of everyday living standard, therefore outing, travel, and the chance for adventuring outdoor has increased substantially, so that a navigation device has gradually become a necessary piece of equipment for a car on the road.

A navigation device generally includes a plurality of electronic map images and a navigation procedure, wherein the navigation procedure calculated the current location of the navigation device according to satellite signals received by a global position system (GPS) component of the navigation device, so as to display relevant electronic map images and the location of the navigation device upon the electronic map images. Thereby a driver may clearly realize current location through the electronic map images, in additional to surrounding area information, furthermore via the path mapping and path navigation function provided by the navigation procedure, by simply moving according to the directions provided by the navigation procedure, the chance of being lost is greatly reduced.

A general electronic map images usually includes a plurality of build-in point of interest (POI), such as: restaurants schools, shopping malls, government facilities, major highways, and parking lots, so as to facilitate a user to select a POI, then via the navigation procedure the mapping of a navigation path may be executed so as to map a path from the current location of the navigation device to the location of the POI (i.e. target position, which may be inferred from the address information of the POI), so that the user may quickly and conveniently plan the best route to the target position. Therein the information of the current location of the navigation device may be referred to as the location information. However, the POI information provided on the electronic map images may be limited, and the driver may only receive information regarding a POI's general nature (restaurant, school, highway . . . etc) or a POI's target position; furthermore the POI information in a conventional navigation device may not be interactive, so that it is possible for the user to drive for a long distance only to arrive at a target restaurant and finding the restaurant has closed for holiday or the seating is full.

Additionally, if a POI is not build-in and displayed on the electronic map images and if the address of the POI is not known, then the navigation procedure of a conventional navigation device can not proceed with the path mapping and the path navigation.

Therefore how to design an intelligent navigation device so as to resolve the aforementioned issue is an important matter that requires urgent attention.

### SUMMARY OF THE INVENTION

In view of the aforementioned issues, the present invention provides an intelligent navigation device, which includes a location module, a wireless communication unit, a memory unit, a processing unit, an input unit, and a display unit. The location module is for providing a location information; the wireless communication unit is for wireless transmitting and receiving data. The memory unit has an image database and a navigation and search procedure stored therein; the image database includes a plurality of electronic map images; and the navigation and search procedure is for path navigation and searching data on the web. The processing unit is coupled between the location module, the wireless communication unit and the memory unit; wherein the processing unit is for executing the navigation and search procedure according to the location information, so as to generate a navigation path on the electronic map images. The input unit is coupled to the processing unit, and the input unit is for providing a user with a way to input a specific term into the intelligent navigation device, wherein the specific term is a term used for searching. The display unit is coupled to the processing unit, for displaying the navigation path and at least a website information related to the specific term; wherein the website information is found by the navigation and search procedure according to the specific term.

The present invention further discloses a control method of an intelligent navigation device; the intelligent navigation device includes a plurality of electronic map images. The control method includes the following steps: first, inputting a target position; next, mapping a navigation path on the electronic map images according to a location information of the intelligent navigation device and the target position, wherein the electronic map images includes a plurality of facility images; and lastly, selecting one of the facility images, so as to enter a website related to the facility images.

The above-mentioned summary and subsequent detailed descriptions as well as appended drawings are all illustrations of approaches, means and effects adopted by the present invention to achieve the prescribed purposes. Other objectives and advantages related to the present invention will be further elucidated in the following specification and diagrams. However the appended drawings are for reference and illustration purpose only, and is not meant to limit the present invention.

### BRIEF DESCRIPTION OF THE DRAWINGS

FIG. 1 is a functional block diagram of an intelligent navigation device according to an embodiment of the present invention;

FIG. 2 is a schematic diagram of a navigation device interface according to an embodiment of the present invention;

FIG. 3 is a schematic diagram of a navigation device interface according to another embodiment of the present invention;

FIG. 4 is a schematic diagram of a navigation device interface according to yet another embodiment of the present invention;

FIG. 5 is a schematic diagram of a navigation device interface according to a further embodiment of the present invention;

FIG. 6 is a schematic diagram of a navigation device interface according to another further embodiment of the present invention; and

FIG. 7 is a flowchart of the control method for the intelligent navigation device according to an embodiment of the present invention.

### DETAILED DESCRIPTION OF THE PREFERRED EMBODIMENTS

The present invention provides an intelligent navigation device and a control method thereof, which adds internet search functionality to the navigation device, so that in the process of navigation, more useful information may be obtained, so as to increase the convenience of the navigation.

The primary characteristic of the present invention is to add a mechanism for connecting to the internet, hereafter only the necessary system structure and action flow is mentioned; however, as those skilled in the art knows, besides the structure components mentioned hereafter, a navigation device of course includes other required components and forms, therefore, the following embodiments should not be deemed as limiting to the present invention.

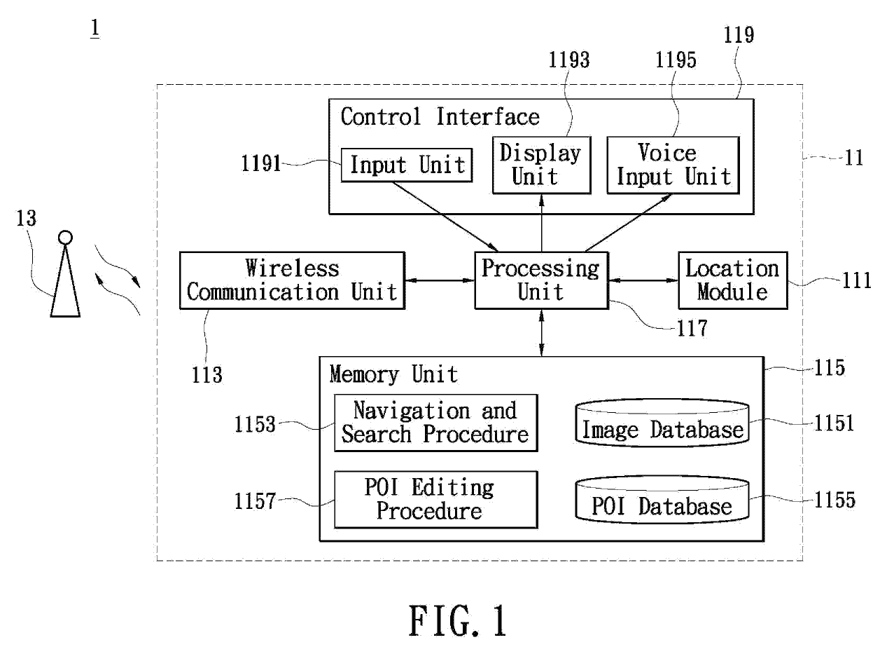

First, please refer to FIG. 1, which shows a functional block diagram of an intelligent navigation device according to an embodiment of the present invention. As shown by FIG. 1, the intelligent navigation device 11 is used within an intelligent navigation system 1; the intelligent navigation system 1 includes at least a base 13; the base 13 is in cooperation relation with the intelligent navigation device 11 and provides at least an internet service, so as to transmit information to the intelligent navigation device 11. Specifically speaking, the intelligent navigation device 11 may include those hand-held devices such as a mobile phone, a stock trading assistant, or a personal digital assistant (PDA).

The intelligent navigation device 11 includes a location module 111, a wireless communication unit 113, a memory unit 115, a processing unit 117, and a control interface 119. The processing unit 117 is coupled between the location module 111, the wireless communication unit 113, the memory unit 115, the processing unit 117, and the control interface 119, and the processing unit 117 is for controlling the operation of these components. The location module 111 is for receiving a satellite signal, so as to generate a location information of the intelligent navigation device 11, wherein the location information indicates the current location of the intelligent navigation device 11. Specifically speaking, the location module 111 is a global positioning system, GPS. The wireless communication unit 113 is for wireless transmitting and receiving the internet service, e-mail service, multi-media file data provided by the base 13. Specifically, the wireless communication unit 113 may be Bluetooth, infrared, IEEE 820.11x, WiFi communication module, WiMax communication module, 2.5G (General Packet Radio Service, GPRS), 3G, 3.5G, or 4G communication module.

The control interface 119 includes an input unit 1191, for providing a user with a way to input a control command into the intelligent navigation device 11, specifically speaking the input unit 1191 may be of any combination from the group consisting of a remote control, a press button device, multi-step switch, or a sensor device; a display unit 1193, for displaying control and operation result; and a voice input unit 1195, for receiving a voice data so as to control the operation of the intelligent navigation device 11.

The memory unit 115 has the following stored: an image database 1151, a navigation and search procedure 1153, a point of interest (POI) database 1155, and a POI editing procedure 1157. The image database 1151 includes a plurality of electronic map images and a plurality of facility images. The navigation and search procedure 1153 is for providing path navigation and data searching functionality, such as searching data on the web. The POI database 1155 includes a plurality of POI information, each of the POI information has the name, address, coordinate, and website address information of a POI recorded; specifically speaking, every POI on the electronic map images may represent restaurant, hospital, gas station, stores, etc, wherein related and corresponding facility images may be used to represent the POI to be displayed on the electronic map images. The POI editing procedure is for editing, adding, and deleting the information of the POI.

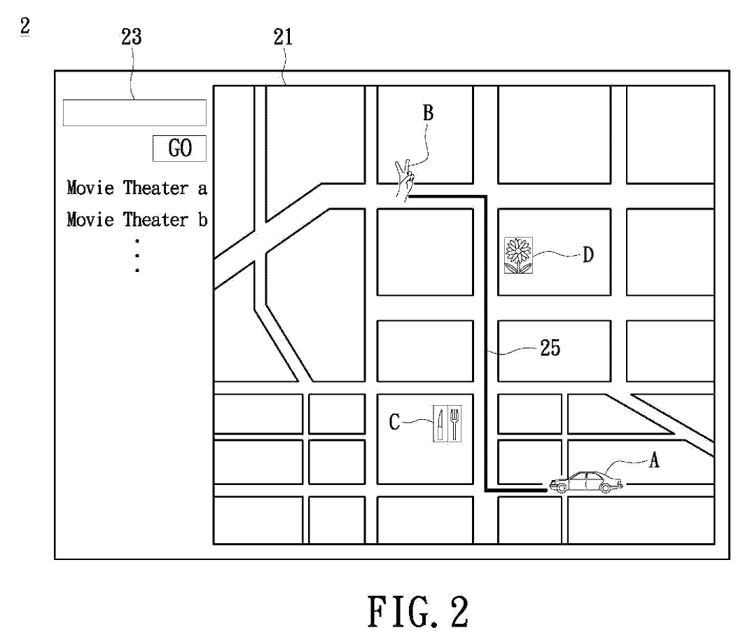

Please refer to FIG. 2, which shows a schematic diagram of a navigation device interface according to an embodiment of the present invention. As shown by FIG. 2, when the intelligent navigation device 11 is activated, the processing unit 117 activates the relevant electronic map images 21 for display on the display unit 1193 according to the location information (i.e. the location information of the intelligent navigation device 11); furthermore a predetermined facility image A may be used to represent current location of the intelligent navigation device 11. The user may a target location address term or any POI name stored within the POI database 1155 into an input bar 23 so as to proceed with navigation, the processing unit 117 then executes the navigation and search procedure 1153, so that an optimum navigation path 25 may be generated from the starting point to the target destination. Besides entering specific terms, voice input may also be used, wherein the voice input unit 1195 may recognize the target destination so as to proceed with navigation. The user may also select any POI, as represented by corresponding facility images, on the electronic map images so as to receive the address information of the POI. The processing unit 117 then executes the navigation and search procedure 1153 according to the location information (current location of the intelligent navigation device 11) and the address information (the intended destination), so as to generate a navigation path on the electronic map images 21.

In the process of navigation, the processing unit 117 may search and find from the POI database 1155 the POI information of those POI within the range of the relevant electronic map images 21, furthermore uses relating and corresponding facility images C, D to represent the location of those POI. Therein, the POI displayed on the electronic map images 21 may be of commercial businesses that have cooperation relation with telecommunication company has access to the base 13, so that information and services of POI may be provided; additionally the user may also executes the POI editing procedure 1157 so as to edit and save the POI information within the POI database 1155 for future reference.

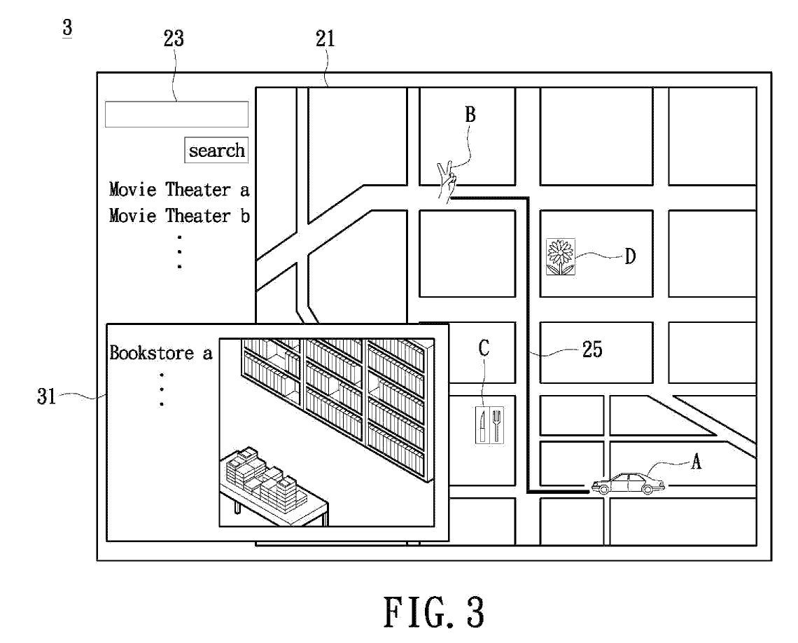

Next, please refer to FIG. 3, which shows a schematic diagram of a navigation device interface according to another embodiment of the present invention. Because the POI information includes the website address of the POI therefore the user may directly select the POI represented by the facility image on the electronic map images 21 se as to open and enter the website of the POI. As shown by FIG. 3, if the user selects the POI represented by the facility image C, the processing unit 117 then opens a window interface 31 to display the website of the POI, so as to facilitate the viewing and usage of the resource of the website, for example: making a reservation, searching for food menu, and other services.

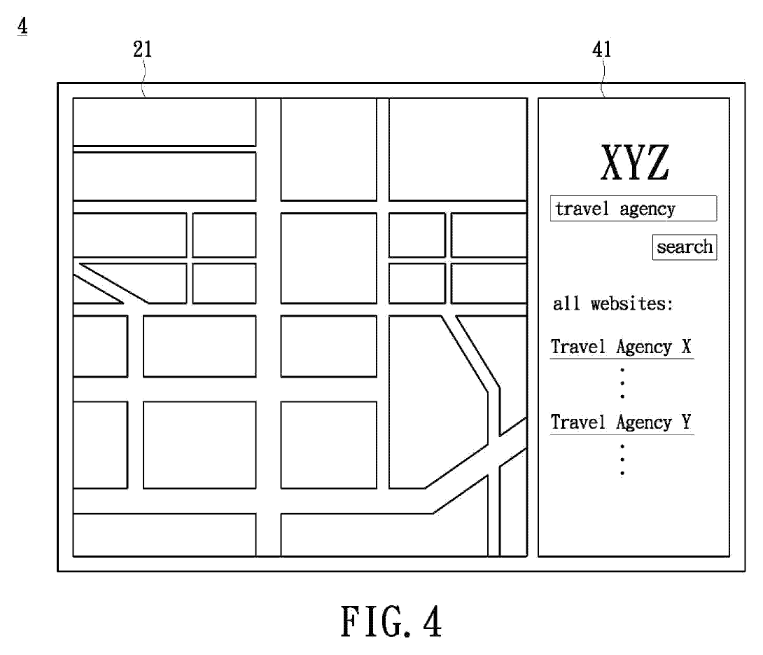

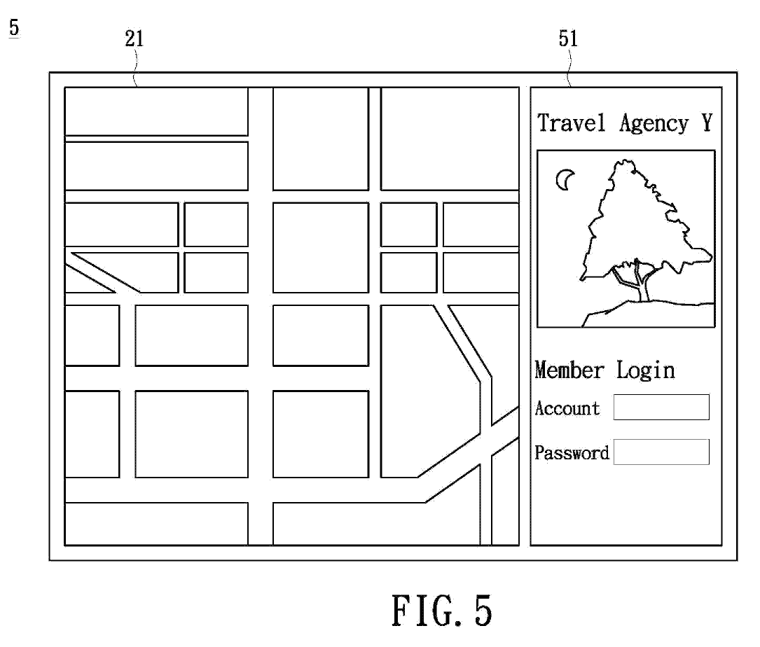

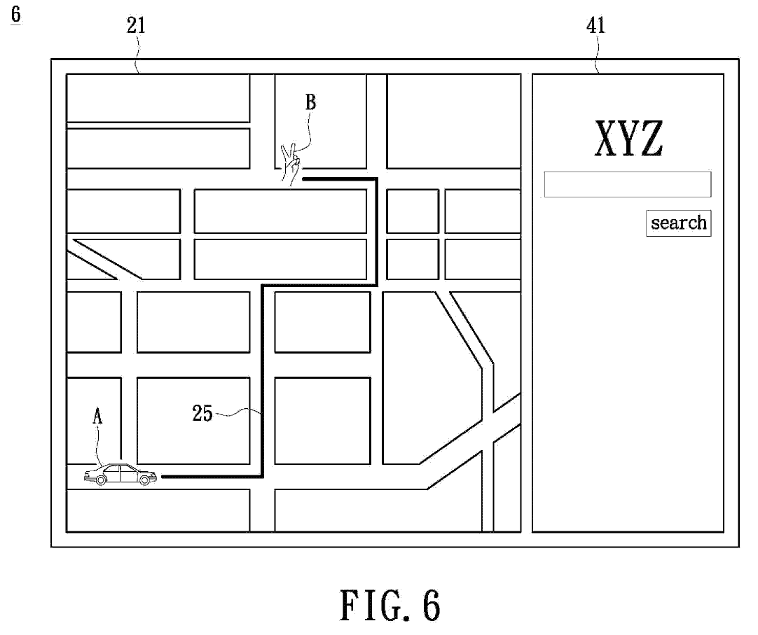

Besides providing a general navigation mode as described above, the navigation and search procedure 1153 also provides an internet navigation mode, so that in the process of navigation, there may be functionality of information search. Please refer to FIG. 4, which shows a schematic diagram of a navigation device interface according to yet another embodiment of the present invention. As shown by FIG. 4, the navigation device interface 4 besides displaying the electronic map images 21, also displays a search site 41, which is provided for searching information. The user may enter a specific term into the search site 41 (i.e.; the specific term may be the name of a company), then the display unit 1193 lists the website information found by the search site 41 according to the specific term. The user may selectively be connected to the website 51 after clicking on (i.e. selecting) the listed website information, as shown by the navigation device interface 5 in FIG. 5; or receiving the address information corresponding to the specific term by clicking on (i.e. selecting) the listed website information, the processing unit 117 then executes navigation and search procedure 1153 according to the location information and the address information, as shown by the navigation device interface 6 of FIG. 6, so as to generate a navigation path on the electronic map images 21. Therefore, even when the specific address of the intended destination is not known by the user, or the intended destination address information has not been inputted and stored in the POI database 1155 in advance, the user may still use search site to find the website of the intended destination so as to receive the address of the intended destination along with other relevant information. Therein, by using the POI editing procedure 1157, the user may add the website and location of the stores found within the POI database 1155 for future reference.

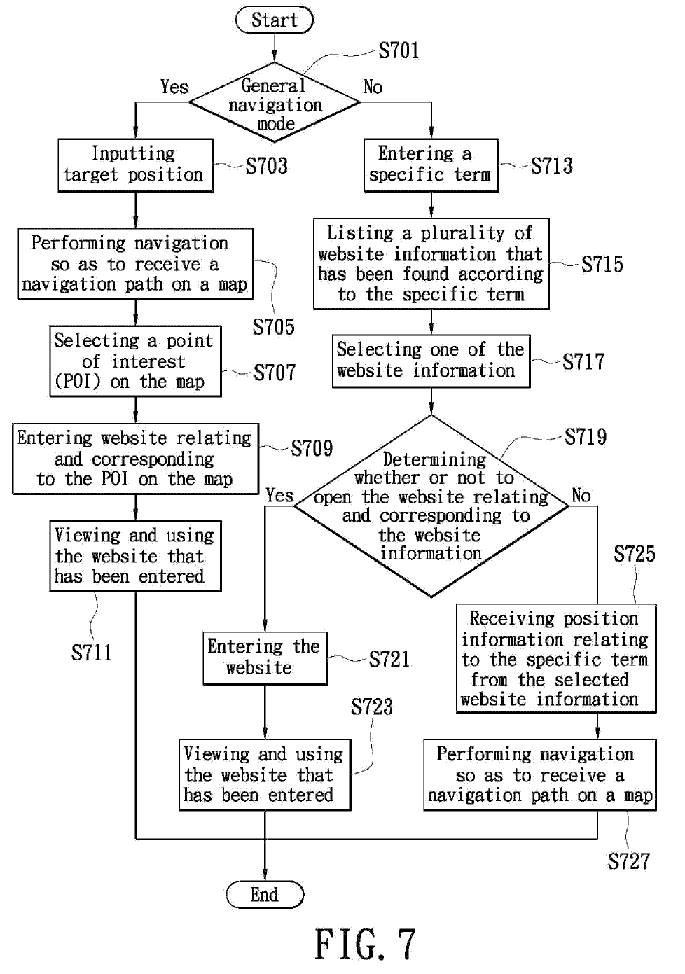

Lastly, please refer to FIG. 7, which shows a flowchart of the control method for the intelligent navigation device according to an embodiment of the present invention. Therein for related system structure please refer to FIG. 1 in conjunction. As shown by FIG. 7, the steps of the control method is as follow:

First, after activating the intelligent navigation device 11, the user may select a desired navigation function (i.e. the general navigation mode or the or the internet navigation mode) from the main selection screen (not shown) on the display unit 1193; specifically, after entering a control interface of the navigation screen, the user may select a navigation mode according to the user's needs; the processing unit 117 determines whether or not general navigation mode has been selected (S701); if the determination is yes and the general navigation mode has been selected (please reference FIGS. 2 and 3), then the user may input a target position (S703), the target location may be address terms entered into the input bar 23 of the intelligent navigation device 11 or any POI recorded within the POI database 1155;

Next; the processing unit 117 executes the navigation and search procedure 1153 according to the location information (i.e. current location of the intelligent navigation device 11) and the target position (i.e. intended destination location), so as to generate a optimum navigation path 25 from a starting point such as the current location of the intelligent navigation device 11 to the intended target position on the electronic map images 21 (S705); in the process of the navigation, the user may select a POI on the electronic map images 21 that is represented by a related and corresponding facility images (S707); the processing unit 117 then finds the website address information of the selected POI from the POI database 1155, and opens a window interface 31 to display the website relevant to the POI according to the website address information (S709); thereby the user may view and use the website that has been opened and entered (S711);

If the determination in step S701 is No, then that means the user intends to proceed with the internet navigation mode (please reference FIGS. 4-6), wherein the user may search for the location of the intended destination via the internet; once in the internet navigation mode, the user may enter a specific term into a search site 41 displayed on the display unit 1193 (S713), then the display unit 1193 lists the website information found by the search site 41 according to the specific term (715); after selecting the listed website information which may be a link (S717); the processing unit 117 determines whether or not to open the website corresponding to the website information (S719), specifically speaking, the processing unit 117 may open a selection window for the user to determine either open and enter the website or proceed with navigation of path mapping to the address information found according to the specific term;

If the determination in step S719 is Yes, then enter the website and display the content of the website (S721), so that the user may use the website that has been entered (S723); if in the step of S719 the user selects No, which is to proceed with path navigation, then processing unit 117 receives the position information of the POI relating to the specific term from the selected website information (S725), then executes the navigation and search procedure 1153 according to the location information of the intelligent navigation device 11 and the address information of the intended destination, so as to generate an optimum navigation path 25 from the starting point to the intended destination (S727); similarly, in the process of navigation, the user may also select any POI represented by the facility images that is displayed on the electronic map images 21, so as to enter and view the website of the POI.

Besides path navigation function, the intelligent navigation device 11 may also provides other functions such as wireless internet connection, email sending and receiving, basic device function setting selections, positioning setting related to the GPS system, multi-media broadcasting

As per the aforementioned descriptions of embodiments, the intelligent navigation device and the control method thereof of the present invention has been disclosed, wherein by adding the internet search functionality into the navigation device, the following advantages may be achieved.
1) In the process of navigation, the user may directly open the website of the POI from the facility image displayed on the electronic map images, thereby receive information regarding to the POI.
2) Even when the address of the intended destination is not known, and the base (i.e. a telecommunication base that provides information regarding POI) did not provide the address information of the intended destination, the address of the intended destination may still be searched and found via the internet. Therefore the present invention besides providing direct viewing of the related website to the POI, the intelligent navigation device may also still perform path navigation, thereby provides convenience of use.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. An intelligent navigation device, comprising:
a location module, for providing a location information;
a wireless communication unit, for wireless transmitting and receiving data;
a memory unit, which has the following stored therein:
an image database, which includes a plurality of electronic map images; and
a navigation and search procedure, for path navigation and searching data on the web,
a processing unit, coupled between the location module, the wireless communication unit, and the memory unit, for executing the navigation and search procedure according to the location information, so as to generate a navigation path on the electronic map images:
an input unit, coupled to the processing unit, for providing a user with a way to input a specific term into the intelligent navigation device, wherein the specific term is used for searching; and
a display unit, coupled to the processing unit, for displaying the navigation path and at least a website information related to the specific term; wherein the website information is found by the navigation and search procedure according to the specific term.

2. The intelligent navigation device according to claim 1, wherein the memory unit further comprising:
a point of interest (POI) database, which includes a plurality of POI information, each of the POI information has the name, address, coordinate, and website address information of a POI recorded;
wherein, the image database further includes a plurality of facility images, and the POI is displayed and represented on the electronic map images via one of the facility images.

3. The intelligent navigation device according to claim 2, wherein the memory unit further has a POI editing procedure stored therein, for editing, adding, and deleting the information of the POI.

4. The intelligent navigation device according to claim 3, wherein the POI information is provided by a remote base or generated by the POI editing procedure.

5. The intelligent navigation device according to claim 2, wherein the user selects the facility image representing the POI, so that the processing unit opens a window interface to display the website of the POI according to the website address information of the POI.

6. The intelligent navigation device according to claim 2, wherein the user selects the facility image representing the POI so as to receive the address information of the POI, the processing unit executing the navigation and search procedure according to the location information and the address information, so as to generate the navigation path on the electronic map images.

7. The intelligent navigation device according to claim 1, wherein the user selects the website information so as to connect to a corresponding website.

8. The intelligent navigation device according to claim 1, wherein the user selects the website information so as to receive an address information, the processing unit executing the navigation and search procedure according to the location information and the address information, so as to generate the navigation path on the electronic map images.

9. The intelligent navigation device according to claim 1, further comprising a voice input unit, for receiving a voice data, wherein the processing unit executes the navigation and search procedure according to the location information and the voice data, so as to generate the navigation path on the electronic map images.

10. The intelligent navigation device according to claim 1, wherein the input unit is any combination from the group consisting of a remote control, a press button device, a multi-step switch, or a sensor device.

11. A control method of an intelligent navigation device, the intelligent navigation device includes a plurality of electronic map images, the control method comprising the following steps:
inputting a target position;
mapping a navigation path on the electronic map images according to a location information of the intelligent navigation device and the target position, wherein the electronic map images includes a plurality of facility images; and
selecting one of the facility images, so as to enter a website related to the facility images.

12. The control method according to claim 11, wherein prior to the step of inputting the target position further comprises the following steps:
providing a general navigation mode and an internet navigation mode for the intelligent navigation device;
determining whether or not to enter the internet navigation mode; and
if the determination is yes, then executing the following steps:
entering a specific term, so as to search for at least a website information related to the specific term;
selecting one of the website information so as to either selectively open the website relating and corresponding to the website information or receive an address information corresponding to the specific term; and
if the address information corresponding to the specific term has been received, then mapping the navigation path on the electronic map images according to the location information and the address information.

13. The control method according to claim 12, further comprising the following steps:
editing the information related to the specific term as a POI information, wherein the POI information includes the name, address, coordinate, and website address information of a POI.

14. The control method according to claim 13, wherein the information corresponding to the facility images is provided by a remote base or generated by editing the POI information.

15. The control method according to claim 14, wherein the intelligent navigation device communicates with the base in a wireless way.

16. The control method according to claim 11, wherein after the step of entering a website related to the facility images further comprises the step of viewing and using the website that has been entered.

17. The control method according to claim 12, wherein the input of the target position and the specific term is according to a voice input way or word-keying input way.
